(19) United States
(12) Patent Application Publication
(10) Pub. No.: US 2026/0202192 A1
(43) Pub. Date: Jul. 16, 2026

(54) Method, measuring arrangement and system for measuring an internal contour, in particular an internal thread on a sleeve or a sleeve end of a pipe

(71) Applicant: SMS group GmbH, Mönchengladbach (DE)

(72) Inventors: Frank D'HONE, Köln (DE); Christian HOLLÄNDER, Niederkrüchten (DE); Martin SAUERLAND, Niederkrüchten (DE)

(73) Assignee: SMS group GmbH, Mönchengladbach (DE)

(21) Appl. No.: 19/136,878

(22) PCT Filed: Sep. 18, 2023
(86) PCT No.: PCT/EP2023/075610

§ 371 Date: Jun. 8, 2025

(30) Foreign Application Priority Data
Dec. 15, 2022 (DE) 10 2022 213 730.2

(51) Int. Cl. G01B 11/24; G01B 11/12

(52) U.S. Cl. CPC G01B 11/2425; G01B 11/12

(57) ABSTRACT

A method for measuring an internal thread on a sleeve or a sleeve end of a pipe uses a measuring arrangement with a first inner sensor and at least a second outer sensor. The sensors are arranged radially at a defined distance from each other with respect to a longitudinal axis of the pipe. The first sensor detects the inside of the pipe, and the second sensor detects the outside of the pipe. The first sensor scans the internal thread at least in a first measurement pass along a first measuring section parallel to a longitudinal axis of the pipe. The measurement signals of the second outer sensor determine the external diameter of the pipe as a reference for the measurement signal of the first sensor. The detected measurement values are stored and/or processed using means for electronic data processing for the purpose of mapping a thread profile.

### CROSS-REFERENCE TO RELATED APPLICATION

This application is a national stage application, filed under 35 U.S.C. § 371, of International Patent Application PCT/EP 2023/075610, filed on Sep. 18, 2023, which claims the benefit of German Patent Application DE 10 2022 213 730.2, filed on Dec. 15, 2022.

### TECHNICAL FIELD

The disclosure relates to a method for measuring an internal contour, in particular an internal thread on a sleeve or a sleeve end of a pipe. The disclosure further relates to a measurement arrangement for measuring an internal contour, in particular an internal thread on a sleeve or a sleeve end of a pipe, in particular for carrying out the method, as well as a measuring system for measuring an internal contour, in particular an internal thread on a sleeve or a sleeve end of a pipe, which is designed in particular to carry out the method and which comprises a measurement arrangement of the type described above.

### BACKGROUND

Pipes that are used to transport pressurized fluids, such as natural gas or crude oil, and that are screwed together in a pressure-resistant, gas-tight and liquid-tight manner, must meet high requirements in terms of tightness. Conical threads with undercut thread flanks are usually used for such OCTG pipes as casing pipes or riser pipes for crude oil or natural gas exploration wells or natural gas or crude oil production lines. The threads are usually followed by a sealing lip on the end face of the pipe. Both the thread and the sealing lip must fulfil the highest precision requirements. In the prior art, it is generally known to optically measure the threads for quality control of the pipes.

In principle, the measurement of external pipe threads is unproblematic insofar as the external thread is easily accessible from the outside and can be measured both without contact and using tactile sensors. The measurement of internal threads is more difficult due to the poorer accessibility of the internal threads. It is generally known to measure threads using tactile measuring equipment, for example with thread gauges or tactile probes.

Measuring internal threads on pipes with a relatively small diameter, for example with a diameter of less than 100 mm, is particularly difficult as the clear width of the pipe only allows the insertion of a single sensor. To determine the internal diameter, which is required to map the thread profile, at least two and ideally three measuring points must be recorded. If optical sensors are to be used without contact to scan the internal thread, the relatively small distance between the sensor and the thread inside the pipe also causes problems.

In addition, the internal thread measurement is regularly associated with the difficulty that the internal diameter of the pipe is not always concentric to the external diameter, particularly due to the manufacturing method, for example in the case of seamlessly manufactured rolled pipes. It is therefore necessary for the internal thread measurement to determine the internal diameter or the position of the internal diameter relative to the external diameter.

A method and a device for optically measuring the external thread profile of pipes is known, for example, from WO 2019/09371 A1.

A method and a device for inspecting the external thread of an oilfield pipe are known from WO 2012/069154 A1, wherein the device comprises a sensor guided on a frame and wherein the sensor is arranged on a threaded support, the thread of which is formed in accordance with the thread of the pipe and which surrounds a part of the conical thread of the pipe to be inspected. The sensor is designed as a confocal sensor.

A device for measuring threads on oilfield pipes is also known from WO 2020/232041 A1. The device comprises a sensor unit which is designed to measure a distance between the sensor and a part of the thread of the metal pipe. The sensor or the sensor unit can be adjusted radially and axially with respect to the internal thread of the metal pipe using a plurality of actuators, wherein a control device can generate a three-dimensional image of the internal thread from a plurality of distance measurements. The sensor unit comprises a confocal chromatic sensor, which is brought into the metal pipe on a rod assembly and centred inside the metal pipe by means of sensing rollers. After concentric alignment of the guide rod of the rod assembly, the sensor is adjusted both translationally and rotationally within the metal pipe, wherein the thread is scanned and a three-dimensional image of the thread is generated using the measurement data obtained in this way.

The arrangement known from WO 2020/232041 A1 is not readily suitable for pipes with a small internal diameter. The tactile centring of the measuring arrangement is complex and requires a relatively large amount of installation space. The field of view of the sensor is aligned at a predetermined angle to the longitudinal axis of the metal pipe and the rod to which the sensor is attached can be actuated by means of three different actuators, wherein one actuator is provided for the rotational movement of the rod around its own longitudinal axis, one actuator for a rotational movement of the rod around the longitudinal axis of the metal pipe and one actuator for a linear movement of the rod within the metal pipe, i.e. parallel to the longitudinal axis of the metal pipe. The scanning of undercut and/or conical threads is difficult with this arrangement.

A non-contact sensor-based measuring method for internal threads on pipes is known from CN 112871737 A, in which the position of the axis of symmetry of the external thread and the position of the axis of symmetry of the internal thread relative to that of the external thread are first determined. It is also proposed in CN 112871737 A to rotate the pipe to be measured around its own axis using a sensor aligned in the longitudinal direction of the pipe and measure the axial offset. Alternatively, it is provided to clamp the pipe and determine the position of the axes relative to each other in a centring device by adjusting the clamping accordingly. The internal thread is detected by guiding the optical sensor along the previously determined longitudinal axis of the internal diameter of the pipe. This method is relatively expensive.

### SUMMARY

An object of the disclosure is to provide a method, a measuring arrangement and a system which enable non-contact measurement of the internal thread on pipes, in particular on metal pipes having a small internal diameter. In particular, the method should be designed such that it can be carried out with just one sensor on the inside of the pipe.

The object is solved by providing a method having the features as described herein, and by providing a measurement arrangement having the features as described in this application. Furthermore, a measuring system is provided.

A first aspect of the invention relates to a method for measuring an internal contour, in particular an internal thread on a sleeve or a sleeve end of a pipe using a measuring arrangement having at least two sensors, wherein the measuring arrangement comprises a first inner sensor and at least one second outer sensor, wherein the first inner sensor and the second outer sensor are arranged at least radially with respect to a longitudinal axis of the pipe at a defined distance from one another, wherein the measuring arrangement is arranged with respect to the sleeve or the sleeve end of the pipe in such a way that the first sensor detects the inside of the pipe and that the second sensor detects the outside of the pipe, wherein the method comprises that the first sensor scans the internal thread at least in a first measuring run along a first measuring section parallel to a longitudinal axis of the pipe, wherein the measuring signals of the second outer sensor determine the outer diameter of the pipe as a reference for the measuring signal of the first sensor, and wherein the detected measured values are stored and/or processed with means for electronic data processing for the purpose of mapping a thread profile. The recorded actual thread profile is preferably compared with a target thread profile in a further method step, such that the pipe can be rejected if the dimensions are outside the predetermined tolerances.

The term internal thread also comprises unthreaded sections of the sleeve, in particular a sealing lip provided on OTCG pipes.

The measurement of the internal thread can in particular be coupled with an automated threading process of a machine tool. By way of example, it can be provided that the method uses a preferably closed control loop between the machining of the metal pipe and the thread measurement, wherein a direct evaluation and derivation of control commands for the machine tool takes place in an advantageous manner depending on the comparison of the detected actual thread profile with a target thread profile.

A control device provided, for example, in a machine control system of the machine tool for evaluating and deriving control commands can comprise at least one self-learning algorithm for deriving the control commands.

In principle, it can be provided to rotate the pipe around its longitudinal axis during a measuring run. If the pipe is rotated precisely around its longitudinal axis, exactly two sensors arranged inside and outside at a defined distance from each other are sufficient to determine the diameter and to determine the contour of the pipe.

In the method, it is provided to establish a metrological reference to the outer diameter of the pipe for measuring the internal thread of the pipe, such that the internal thread of a sleeve or pipe can be measured with just a single sensor inside the pipe.

The fine thread structure including the tooth height, the tooth width, the flank angle, the rounding angle and the pitch are precisely determined for a complete description of the internal thread.

For this purpose, it can be provided to clearly and precisely determine the exact position of the internal thread in space, i.e. also the position of the internal diameter in relation to the external diameter of the pipe. At least three measuring points are advantageous for this purpose. This can be implemented with two sensors, for example, if the pipe is rotated around its longitudinal axis.

It is preferable to provide an inner sensor and multiple outer sensors, which are preferably mechanically connected to each other and have a precisely defined radial distance to each other. The outer diameter of the pipe determined by the outer sensors forms a reference for the measurement signal of the inner sensor. Preferably, the measuring arrangement comprises at least one third outer sensor, which also has a defined radial distance to the first and second sensors and which also detects the outer side of the pipe. By detecting three measuring points on the outer circumference of the pipe, a mathematically exact description of the circular lateral surface of the pipe is possible.

However, the method can also be carried out with satisfactory results if only two measuring points on the outer circumference of the pipe are recorded.

The inner sensor and the outer sensors are preferably moved parallel to each other in the longitudinal direction of the pipe during a measuring run.

The measuring arrangement can be designed in such a way that the radial distance between the inner and outer sensor(s) is changed according to the conicity of the sleeve during a measuring run in the longitudinal direction of the pipe. This ensures that there is a correspondingly large distance between the sensors over the length of a measuring section on each pipe cross-section such that the measurement can be carried out with corresponding accuracy. By way of example, a distance calibration of the sensors can be carried out at the beginning and end of an intended reference section, for example on a reference object. During a measurement run on the pipe to be measured, the radial distance between the sensors, i.e. the distance between the inner sensors and the at least one outer sensor, can be adjusted. Preferably, the radial distance between the outer sensors can also be adjusted. The inner sensor and/or the at least one outer sensor can be moved radially.

The measuring arrangement preferably comprises a measuring head that can be moved relative to the pipe. The measuring head can, for example, comprise at least two sensors or measuring arms with sensors to be arranged on the outer circumference of the pipe, which are adjusted in the manner of a fork or tongs by means of at least one linear drive for varying the distance between the inner sensor and the outer sensors relative to one another.

In a preferred variant of the method, it is provided that, in at least one second measuring run, the internal thread of the pipe is scanned along a second measuring section parallel to the longitudinal axis of the pipe, wherein the second measuring run is carried out along a measuring section with an angular offset relative to the circumference of the pipe.

The measuring of the internal thread can be scanned over a plurality of measuring runs carried out with an angular offset in relation to the circumference of the pipe. It is preferably provided to carry out two measurements each having an angular offset of 180° in relation to the circumference of the pipe. Alternatively, three measurement runs can be carried out with an angular offset of 120 degrees.

The method preferably comprises the step of calibrating the radial distance between all sensors, for example using a reference object. The reference object can be a sample pipe or specimen having dimensions of a defined tolerance.

Furthermore, it can be provided to travel along the conical inner contour of the pipe in parallel by moving a calibrated, fixed measuring range of the inner and outer sensor in the area of a measurement window of the outer sensor.

By twisting while simultaneously measuring the complete or partial circumference of the pipe, structures caused by the way the pipe is manufactured can be resolved, for example. In the case of seamless rolled pipes, for example, hexagonal wall thickness structures can appear which are still visible after a thread cut and which can impair the quality of the sleeve and/or the pipe.

In principle, the method can be carried out using an inner optical sensor and one or more tactile outer sensors. However, it is provided that at least the first and second sensors are optical sensors selected from a group of sensors comprising laser scanners, sensors designed for laser triangulation, laser micrometers or light-band micrometers, telecentric measuring arrangements with at least one light-sensitive sensor, for example as CMOS or CCD and at least one light source for backlighting an object to be measured, as well as confocal displacement measuring sensors, in particular confocal chromatic displacement measuring sensors.

An optical sensor is also to be understood as an arrangement of multiple optical elements in a measuring section.

For example, the first inner sensor can be designed as a confocal chromatic displacement measuring sensor, whereas two second outer sensors can be designed as light section sensors, for example.

The inner sensor can, for example, be designed in combination with a further optical element, for example in the form of a mirror that can be adjusted around at least one axis, such that an elongated inner sensor can be arranged inside the pipe, which extends parallel to the longitudinal axis of the pipe and which, together with the mirror, enables the inner wall of the pipe to be scanned at right angles to the longitudinal axis of the pipe. The optical element can be designed as a so-called galvo scanner, the mirror of which can be rotated and swivelled relative to the optical axis such that at least a partial circumference of the internal thread of the metal pipe can be optically scanned. The signal detected by the mirror of the optical element is transmitted to the sensor along the optical axis of the arrangement.

The measuring arrangement, which is preferably designed for carrying out the method, expediently comprises a first optical inner sensor and at least two second outer, preferably optical, sensors, which are arranged at a defined and preferably calibrated distance from one another, wherein the arrangement can be moved linearly during a measuring run along a measuring axis over a defined measuring distance and is arranged rotatably around the measuring axis.

The radial distance between the sensors is preferably adjustable, moreover preferably by means of at least one electromotive actuator, such that in particular the arrangement of the second outer sensors in relation to each other can be adjusted in relation to the nominal diameter of the pipes to be measured.

A measuring system for measuring an internal thread on a sleeve or a sleeve end of a pipe, which is designed, suitable and intended for carrying out the method, comprising at least one frame which accommodates an optical bench with a measuring arrangement of the type described above, wherein the optical bench and/or the frame can be adjusted at least linearly in the longitudinal axis or parallel to a longitudinal axis of the pipe by means of at least one drive, and with at least one data processing and data storage device, with which the thread profile of the internal thread can be partially or completely represented. In particular, it is provided to compare the recorded or measured internal thread profile with nominal data of a reference model stored in the data processing device.

The invention is explained below with reference to an exemplary embodiment depicted in the drawings.

### BRIEF DESCRIPTION OF THE DRAWINGS

FIG. 1 shows a schematic depiction of the measuring principle according to the disclosure.

FIG. 2 shows a highly simplified basic depiction of the measuring arrangement.

FIG. 3 is a depiction according to FIG. 2, in which the measuring arrangement is rotated by 180°.

### DETAILED DESCRIPTION

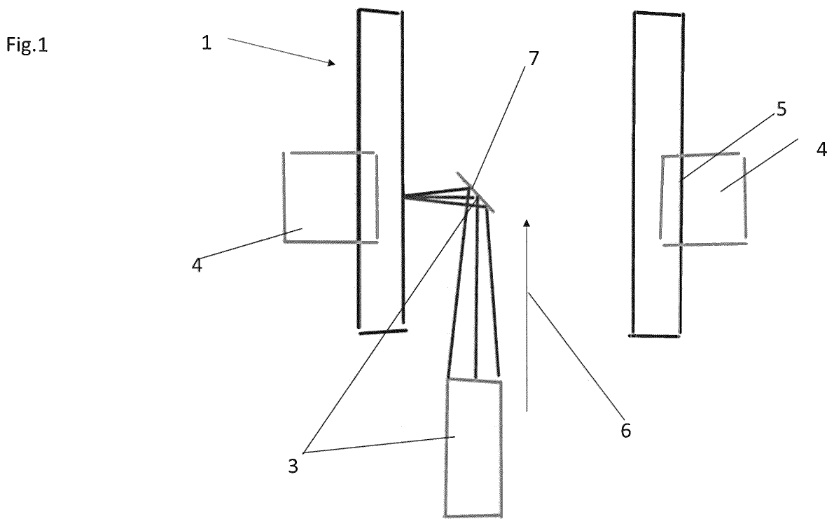

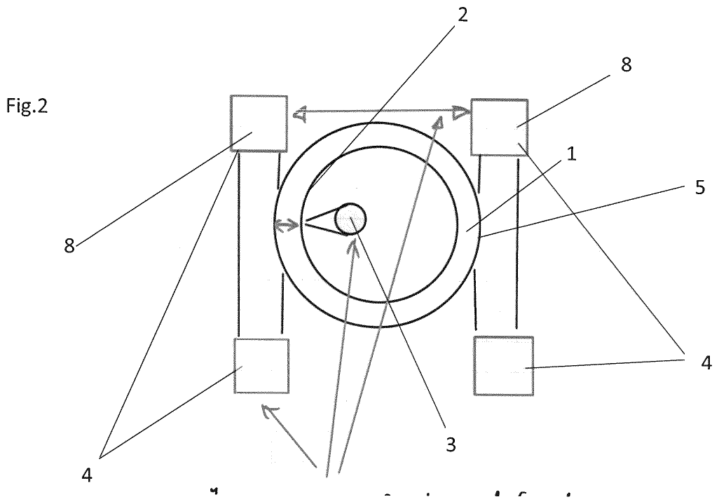

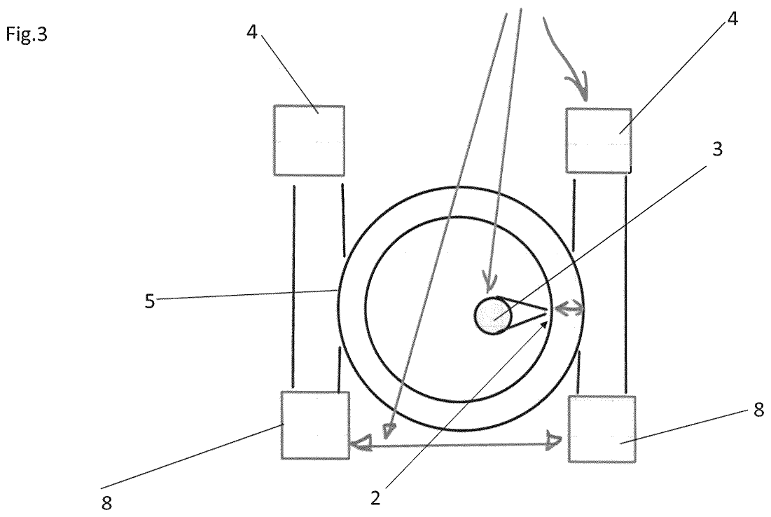

FIG. 1 depicts a highly simplified sleeve end of a pipe 1 having an internal thread 2, which is scanned with a first inner sensor 3 and two second outer sensors 4. The pipe 1 is a metal pipe, for example a seamless rolled metal pipe with a conical internal thread, and is only depicted basically for reasons of simplification. The first inner sensor 3 and the second outer sensors 4 are part of a measuring arrangement depicted only schematically in FIGS. 2 and 3 and can be part of a measuring head, which can be moved along a measuring axis 6 of a measuring section in the direction of the arrow shown in FIG. 1 parallel to the longitudinal axis of the pipe 1 and is arranged rotatably around the corresponding axis. In this context, the terms inner and outer refer to the positions of the sensors 3, 4 during the measuring process or in a ready-to-measure position in relation to the pipe 1. By means of the second outer sensors 4, which are arranged on diametrically opposite sides of the outer casing 5 of the metal pipe 1, the outer diameter of the pipe 1 is recorded as a reference for the measuring signal of the first inner sensor 3. During a measuring run, the first inner sensor 3 is moved along the measuring axis 6 over a predetermined distance into the pipe 1 and scans the internal thread of the pipe 1 optically, i.e. without contact. During a measuring run, the first inner sensor 3 and the outer sensors 4 are moved in parallel, i.e. each aligned with the same cross-section of the pipe 1 and radially opposite each other in the longitudinal direction of the pipe 1. The sensors 3 and 4 are arranged in a measuring arrangement depicted schematically in FIGS. 2 and 3 at a fixed axial and radial distance from each other.

As indicated in FIG. 1, the first inner sensor 3 can be designed as a confocal sensor having a further optical element in the form of a mirror 7, such that the sensor 3 can have a radiation source aligned in the direction of the measuring axis 6, which is deflected at an adjustable angle via the mirror 7, such that it is possible to scan the internal thread 2 of the pipe 1 in a relatively small installation space.

However, the inner sensor 3 can also be designed as a laser scanner or as a different measuring device for detecting the inner contour of the pipe 1 with a different measuring characteristic.

The measuring arrangement depicted in the drawings is designed with two measuring channels. The person skilled in the art will recognise that the measuring arrangement can have more than two channels, which increases the measuring accuracy.

The arrangement shown in FIGS. 2 and 3, for example, shows two outer sensors 4 arranged diametrically opposite each other, each of which has a telecentric optical system with a light-sensitive sensor (receiver), for example a CMOS or CCD sensor.

A light source 8 is arranged opposite each of the light-sensitive sensors, which generates a projection of a part of the outer casing 5 of the pipe 1 onto the light-sensitive sensor 4. The use of telecentric lenses ensures that the projection captured by the respective sensor 4 can be recorded undistorted and true to scale. The measurement data from the second outer sensor 4 recorded in this way is used to determine the outer diameter of the pipe 1 in relation to the distance from the internal thread 2 or the inner casing of the pipe 1 determined by the inner sensor 3.

In a further measurement, which is depicted schematically in FIG. 3, the measuring arrangement is rotated by 180° and the first inner sensor 3 scans the internal thread 2 of the pipe 1 at the diametrically opposite point in relation to the external diameter of the pipe 1 determined by the second outer sensors 4. All sensors 3, 4 have a precisely defined radial distance to each other, which was preferably calibrated using a test specimen before the start of the measurement. The measuring arrangement comprising the first inner sensor 3 and the second outer sensors 4, which are arranged together on a rotatable measuring head, was completely rotated from the position shown in FIG. 2 to the position shown in FIG. 3 in the exemplary embodiment described, wherein a measurement can be carried out intermittently in each case in marked angular positions or also continuously during the rotational movement of the arrangement of sensors 3 and 4.

The entire arrangement is designed to be able to be moved back and forth linearly in the direction of the longitudinal axis of the pipe 1 and also able to be rotated around the longitudinal axis of the pipe 1. It can be provided that both the radial distance and the axial distance between the sensors 3 and 4 are fixed relative to each other and cannot be changed, at least during the measurement runs.

If the conicity of the pipe 1 in the area of the sleeve exceeds a certain level, it can be advantageous to track at least one of the sensors 3, 4 during the measuring runs, i.e. to adjust it radially in a defined manner via a linear guide in order to increase the measuring range of the sensors 3, 4. The radial distance between the second outer sensors 4 can also be variable, for example to adapt to different pipe diameters.

### REFERENCE NUMERAL LIST

1 pipe
2 internal thread
3 first inner sensor
4 second outer sensors
5 outer casing
6 measuring axis
7 mirror
8 light source

1.-13. (canceled)

14. A method for measuring an internal thread (2) on a sleeve or a sleeve end of a pipe (1) using a measuring arrangement having at least two sensors (3, 4), including a first sensor (3) being an inner sensor, and a second sensor (4) being an outer sensor, the method comprising:
arranging the first sensor (3) radially at a defined distance from the second sensor (4) with respect to a longitudinal axis of the pipe (1) such that the first sensor (3) detects an inside of the pipe (1) and that the second sensor (4) detects an outside of the pipe (1);
scanning an internal contour in a first measurement run along a first measuring section parallel to a longitudinal axis of the pipe (1) by the first sensor (3);
determining an external diameter of the pipe (1) as a reference for a measurement signal of the first sensor (3) by measurement signals of the second sensor (4); and
storing and/or processing detected measurement values by electronic data processing for mapping a thread profile.

15. The method according to claim 14, further comprising
rotating the pipe (1) around its longitudinal axis during a measurement run.

16. The method according to claim 14,
wherein the measuring arrangement comprises a further outer sensor (4) arranged at a defined radial distance from the first sensor (3), and
wherein the method further comprises detecting the outside of the pipe (1) by the further outer sensor.

17. The method according to claim 14, further comprising
varying the defined distance between the first sensor (3) and the second sensor (4) during at least one measurement run depending on a conicity of the sleeve.

18. The method according to claim 14, further comprising
scanning the internal thread (2) of the pipe (1) along a second measuring section parallel to the longitudinal axis of the pipe in a second measurement run,
wherein the second measurement run is carried out along a measuring section with an angular offset relative to a circumference of the pipe (1).

19. The method according to claim 18, wherein the angular offset is 180 degrees or 120 degrees.

20. The method according to claim 14, further comprising calibrating the defined distance of the first sensor (3) to the second sensor (4).

21. The method according to claim 20, wherein the calibrating is carried out using a reference object.

22. The method according to claim 14, further comprising
rotating the measuring arrangement between two measurement runs in relation to the pipe (1).

23. The method according to claim 14, wherein the first sensor (3) and the second sensor (4) are optical sensors selected from the group consisting of
laser scanners,
laser triangulation sensors,
laser micrometers,
light-band micrometers,
telecentric measuring arrangements with at least one light-sensitive CMOS or CCD sensor and at least one light source (8) for backlighting an object to be measured,
confocal displacement measuring sensors, and
confocal chromatic displacement measuring sensors.

24. A measuring arrangement for measuring an internal thread (2) on a sleeve or sleeve end of a pipe (1), comprising:
an optical inner sensor (3); and
an optical outer sensor (4), the optical inner sensor (3) being arranged at a defined radial distance from the optical outer sensor (4),
wherein the measuring arrangement is linearly movable along a measuring section defined in a measuring axis (6) during a measurement run and arranged rotatably around the measuring axis (6).

25. The measuring arrangement according to claim 24, wherein the defined radial distance between the optical inner sensor (3) and the optical outer sensor (4) is adjustable by an electromotive actuator.

26. A measuring system for measuring an internal thread (2) on a sleeve or sleeve end of a pipe (1), comprising:
a frame which accommodates an optical bench with the measuring arrangement according to claim 24,
wherein the optical bench and/or the frame is linearly adjustable in or parallel to a longitudinal axis of the pipe (1) by a drive; and
a data processing and data storage device.
